(19) United States
(12) Patent Application Publication
(10) Pub. No.: US 2015/0053788 A1
(43) Pub. Date: Feb. 26, 2015

(54) PESTICIDE SPRAYER

(71) Applicants: Hee Uak Park, Busan (KR); Hong Mo Park, Busan (KR)

(72) Inventors: Hee Uak Park, Busan (KR); Hong Mo Park, Busan (KR)

(21) Appl. No.: 14/076,248

(22) Filed: Nov. 10, 2013

(30) Foreign Application Priority Data
Aug. 20, 2013 (KR) 10-2013-0098271

(51) Int. Cl. A01M 7/00

(52) U.S. Cl. CPC A01M 7/0042; A01M 7/0082
USPC 239/159

(57) ABSTRACT

An electric pesticide sprayer includes: a wagon type body including a driving wheel formed at a lower portion of the body and a box with an inner space formed at an upper portion of the body; a tank provided inside the box to store a pesticide; an impeller provided inside the box, and connected to the tank to convey the pesticide stored in the tank; a distribution unit provided at an end of the impeller to distribute the conveyed a pesticide in left and right directions; left and right hydraulic units connected to distribution unit and installed at front left and right of the wagon type body; and a sprayer including vertical pipes installed at the left and right hydraulic units, respectively, horizontal pipes connected to lower peripheries of the vertical pipes, respectively, and multiple injection nozzles provided at the vertical pipe and the horizontal pipe, respectively.

### CROSS-REFERENCE TO PRIOR APPLICATIONS

This application claims priority of a Korean Patent Application No. 10-2013-0098271, filed on Aug. 20, 2013, which is all hereby incorporated by reference in its entirety.

### TECHNICAL FIELD

The present invention relates to a pesticide sprayer, and more particularly, to an electric pesticide sprayer which is movable in a wagon type and capable of suitably spraying a pesticide to a pepper tree according to a location in a wagon type.

### BACKGROUND

A pesticide sprayer according to the related art includes a compression type pesticide sprayer, a motor type pesticide sprayer, and a tiller compression type pesticide sprayer.

Since the compression type pesticide sprayer uses a method of compressing and spraying a pesticide by operating a lever by a left hand in a state in which a user shoulders an agricultural chemical distribution barrel, pains in a shoulder and a left wrist are increased so that fatigue occurs.

In the motor type pesticide sprayer, pain occurs on a shoulder due to vibration by a rotating motion of a motor in a state in which the user shoulders a pesticide spraying barrel. Further, since only a small amount of a pesticide can be stored, the pesticide must be supplemented frequently. Thus, a working amount is reduced and pain of a right arm is severe.

In the tiller compression type pesticide sprayer, when a pesticide is distributed by a long hose with a high pressure, one person is impossible to operate alone and the work should be done in groups of three. Accordingly, the cost is increased and crops are damaged when a pesticide are directly distributed.

As the related art, Korean registered utility model No. 20-0379029 is disclosed.

Referring to FIG. 1, according to the related art, a wheel wagon type electric pesticide sprayer is disclosed. In the wheel wagon type electric pesticide sprayer, a support is formed at both sides of a wagon wheel 11 shaft. The support is welded at a lower portion of a frame and a water tank 3 for diluting a pesticide is placed on the frame. An input hole for supplying water and a cover are provided at a top portion of the water tank. A rotating wing 4-1 for diluting the pesticide is attached to a lower side of a vertical round bar formed through the cover. A handle is mounted at a top end of the round bar. Two pistons 3 for spraying a pesticide are inserted into the water tank for dilution. A primary pulley 12 fixed at both sides of a wagon wheel shaft is connected to a secondary pulley by a V belt to be moved upward and downward by a fixing member above the piston and the secondary pulley is connected to a rotating object axially fixed to a side of the frame by a V belt so that a kinetic energy of the wagon wheel rotates the rotating object. One side of a crank shaft axially fixed and coupled to an edge of the rotating object is fixed to a shaft of the frame to switch a rotational motion of the rotating object to a rectilinear motion so that a spraying piston is operated upward and downward. A liquid medicine is erupted to an agricultural chemical exhaust port above the piston and is injected by a plurality of spraying nozzles connected with a hose.

However, since the related art is formed by one wheel, it is difficult to drive and spray of the pesticide is restrictive.

### SUMMARY

The disclosure has been made in view of the above problems, and provides an electric pesticide sprayer capable of adjustably spraying a pesticide from a proper height by easily moving a large amount of a pesticide spraying barrel.

In accordance with an aspect of the disclosure, an electric pesticide sprayer includes: a wagon type body including a driving wheel formed at a lower portion of the body and a box with an inner space formed at an upper portion of the body; a tank provided inside the box to store a pesticide; an impeller provided inside the box, and connected to the tank to convey the pesticide stored in the tank; a distribution unit provided at an end of the impeller to distribute the conveyed a pesticide in left and right directions; left and right hydraulic units connected to distribution unit and installed at front left and right of the wagon type body; and a sprayer including vertical pipes installed at the left and right hydraulic units, respectively, horizontal pipes connected to lower peripheries of the vertical pipes, respectively, and a plurality of injection nozzles provided at the vertical pipe and the horizontal pipe, respectively. The driving wheel comprises a front wheel provided at a front side of the driving wheel, a pair of auxiliary wheels provided at a rear side of the driving wheel, and the front wheel receives rotation from a power transmission device by an electric motor. A charger is provided inside the box, a controller including a control switch connected to the charger is provided outside the box to control operations of the electric motor and the impeller according to an operation of the control switch. The controller is connected to a voltage display meter to display a voltage of the charger, and the controller operates a warning sound when the voltage of the charger is 9 V or less. An agricultural chemical insertion hole is formed through the box in a vertical upward direction in which an introduction hole of the tank is formed. A direction control valve is provided at a connecting portion between the vertical pipe and the horizontal pipe to supply the pesticide to the vertical pipe and the horizontal pipe or block of the supply of the pesticide.

### BRIEF DESCRIPTION OF THE DRAWINGS

The objects, features and advantages of the disclosure will be more apparent from the following detailed description in conjunction with the accompanying drawings, in which:

FIG. 1 is a diagram illustrating a configuration of a one wheel wagon type electric pesticide sprayer according to the related art;

FIG. 2 is a diagram illustrating a configuration of an electric pesticide sprayer according to an exemplary embodiment of the present invention;

FIG. 3 is a front view illustrating a configuration of the electric pesticide sprayer according to an exemplary embodiment of the present invention; and

FIG. 4 is a perspective view illustrating a box of the electric pesticide sprayer according to an exemplary embodiment of the present invention.

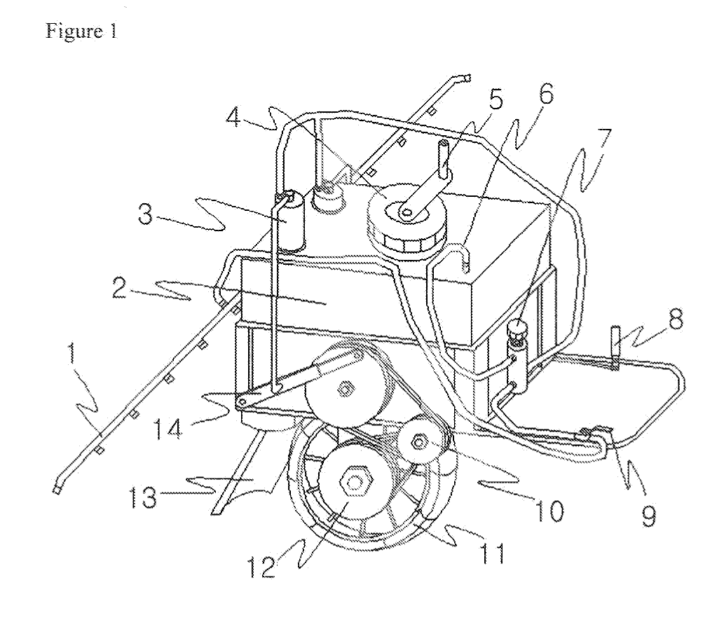

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

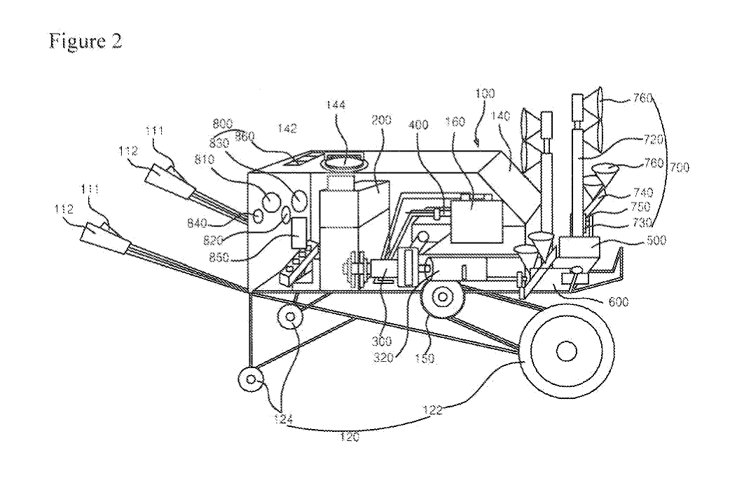

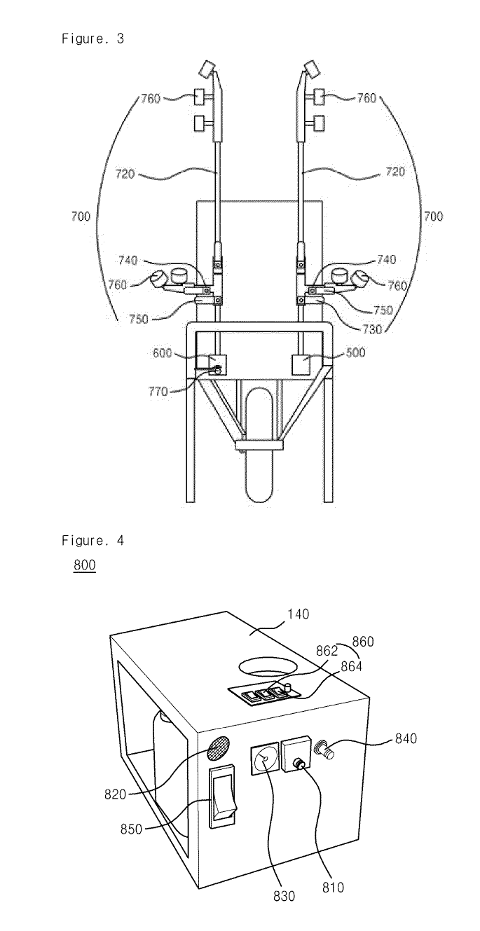

FIG. 2 is a diagram illustrating a configuration of an electric pesticide sprayer according to an exemplary embodiment of the present invention, FIG. 3 is a front view illustrating a configuration of the electric pesticide sprayer according to an exemplary embodiment of the present invention, and FIG. 4 is a perspective view illustrating a box of the electric pesticide sprayer according to an exemplary embodiment of the present invention.

Referring to FIG. 2, the electric pesticide sprayer according to an exemplary embodiment of the present invention includes a body 100, a tank 200, an impeller 300, a distribution unit 400, a left hydraulic unit 500, a right hydraulic unit 600, and a sprayer 700.

The body 100 includes a wagon type body where a driving wheel 120 is formed at a lower portion of the body 100 and a box 140 with an inner space is formed at an upper portion of the body 100.

A front wheel 122 is provided at a front side of the driving wheel 120, and a pair of auxiliary wheels 124 are provided at a rear left and a rear right of the driving wheel 120 so that the driving wheel 120 may be stably driven. The front wheel 122 receives rotation from a power transmission device by an electric motor 150.

An agricultural chemical insertion hole 142 is formed through the box 140 in a vertical upward direction in which an introduction hole of the tank 200 is formed. A circular cover 144 having a shape corresponding to the agricultural chemical insertion hole 142 may be provided in the form of a magnet and may be easily opened and closed.

An agricultural chemical box may be mounted through the agricultural chemical insertion hole 142 so that the pesticide may be easily supplemented into the tank 200.

Meanwhile, handles 112 and 114 are provided at both sides of the body 100, respectively, such that the body 100 may be easily moved. A switch 111 to operate an electric motor is formed at the handle 112 so that a wagon may be driven.

A switch 113 may be provided at the handle 114 to operate an impeller 300, thereby injecting a pesticide by operating the impeller 300.

The power transmission device is achieved by a chain such that power from the electric motor 150 is transmitted to a front wheel 122.

The tank 200 is provided in the inside of the box 140 so that the pesticide is stored in the tank 200.

The impeller 300 is provided in the inside of the box 140 and is connected to a bottom surface of the tank 200 to convey the pesticide stored in the tank.

In this case, the impeller 300 includes a motor 320 to be driven.

The distribution unit 400 is provided at an end of the impeller 300 to distribute the conveyed pesticide in left and right directions to be moved to a left hydraulic unit 500 and a right hydraulic unit 600.

The left hydraulic unit 500 and the right hydraulic unit 600 are connected to the distribution unit 400 to receive the pesticide from the distribution unit 400, and are installed at front left and right of the body 100, respectively.

The sprayer 700 includes vertical pipes 720 installed at the left and right hydraulic units 500 and 600, respectively, horizontal pipes 740 connected to a lower periphery of the vertical pipe 720, respectively, and a plurality of injection nozzles 760 provided at each vertical pipe 720 and each horizontal pipe 740.

FIG. 3 illustrates a front side of the electric pesticide sprayer according to an embodiment of the present invention and shows a detailed configuration of the sprayer 700.

That is, the injection nozzle 760 installed at the vertical pipe 720 injects the pesticide to a top portion of a pepper tree, and the injection nozzle 760 installed at the horizontal pipe 720 injects the pesticide to a bottom portion to be suited to a height of the pepper tree, so that the injection nozzles 760 may be suitably used according to growth of the pepper tree.

It is preferable that three injection nozzles 760 of the vertical pipe 720 are operated, two injection nozzles 760 of the horizontal pipe 740 are operated, and the pesticide is injected within a radius of about 3 m. Further, the injection nozzle 760 injects the pesticide by pressure. If pressure is increased in the inside, the pesticide is circulated by using a drain valve to adjust pressure.

Further, a direction control valve 750 is further provided at a connecting portion between the vertical pipe 720 and the horizontal pipe 740 to supply the pesticide to the vertical pipe 720 and the horizontal pipe 740 or block of the supply of the pesticide.

That is, the direction control valve 750 is used as a four direction port valve so that the horizontal pipe 740 and the vertical pipe 720 are simultaneously opened in one direction, whereas only the horizontal pipe 740 is opened in two directions, only the vertical pipe 720 is opened in three directions, and both of the horizontal pipe 740 and the vertical pipe 720 are blocked in four directions. It is preferable that the horizontal pipe 740 and the vertical pipe 720 are simultaneously opened and all blocked by the opening/closing valve 730 so that the pesticide is supplied to a necessary place.

When it is difficult to perform the operation and spray spraying according to the ground environment, a nozzle connecting hole capable of connecting an external nozzle is further implemented in a right hydraulic unit 600, so that an external hos is connected in a stop state to be manually used.

A charger 160 is provided in the inside of the box 140. A controller 800 including a control switch connected to the charger 160 is provided in the outside of the box 200, so that an operation of the electric motor is controlled by operating the control switch to travel. An operation of the impeller is controlled to spray the pesticide.

A voltage display meter 810 to display a voltage of the charger 160 is connected to the controller 180. When the voltage is 9 V or less, the controller 800 operates a warning device 820 to ring an alarm sound so that the user may easily recognize a lack of voltage of the charger 160. In this case, there is a function of charging the charger 160 and an additional function of a current display meter 830 to display a charging amount.

FIG. 4 is a perspective view illustrating a box of the electric pesticide sprayer according to an exemplary embodiment of the present invention. Referring to FIG. 4, a main power switch 850 is installed at the controller 800 to supply power to an electric operation panel power switch 860, and the electric operation panel power switch 860 includes an injection operation switch 862 to electrically connect an impeller and a drive operation switch 864 to electrically connect a driving motor.

Further, an external charging socket 840 is formed in the box 140 so that the charger 160 is charged by using a charging device. When the charger is charged, if the current display meter 830 reaches a position of 2A˜3A and a current metering needle stops, the charging is completed.

The embodiment of the present invention can load a large amount of a pesticide (about 20 L) and can solve troublesomeness of a frequent supplement of about 2 L. In addition, in every place such as a field or a house of a farm where crops are grown, everybody can easily operate the electric pesticide sprayer and can work alone to improve workability.

Although exemplary embodiments of the present disclosure have been described in detail hereinabove, it should be clearly understood that many variations and modifications of the basic inventive concepts herein taught which may appear to those skilled in the present art will still fall within the spirit and scope of the disclosure, as defined in the appended claims.

What is claimed is:

1. An electric pesticide sprayer comprising:
a wagon type body including a driving wheel formed at a lower portion of the body and a box with an inner space formed at an upper portion of the body;
a tank provided inside the box to store a pesticide;
an impeller provided inside the box, and connected to the tank to convey the pesticide stored in the tank;
a distribution unit provided at an end of the impeller to distribute the conveyed pesticide in left and right directions;
left and right hydraulic units connected to distribution unit and installed at front left and right of the wagon type body; and
a sprayer including vertical pipes installed at the left and right hydraulic units, respectively, horizontal pipes connected to lower peripheries of the vertical pipes, respectively, and a plurality of injection nozzles provided at the vertical pipe and the horizontal pipe, respectively.

2. The electric pesticide sprayer of claim 1, wherein the driving wheel comprises a front wheel provided at a front side of the driving wheel, a pair of auxiliary wheels provided at a rear side of the driving wheel, and the front wheel receives rotation from a power transmission device by an electric motor.

3. The electric pesticide sprayer of claim 2, wherein a charger is provided inside the box, a controller including a control switch connected to the charger is provided outside the box to control operations of the electric motor and the impeller according to an operation of the control switch.

4. The electric pesticide sprayer of claim 3, wherein the controller is connected to a voltage display meter to display a voltage of the charger, and the controller operates a warning sound when the voltage of the charger is 9 V or less.

5. The electric pesticide sprayer of claim 1, wherein an agricultural chemical insertion hole is formed through the box in a vertical upward direction in which an introduction hole of the tank is formed.

6. The electric pesticide sprayer of claim 1, wherein a direction control valve is provided at a connecting portion between the vertical pipe and the horizontal pipe to supply the pesticide to the vertical pipe and the horizontal pipe or block of the supply of the pesticide.
